(19) United States
(12) Patent Application Publication
(10) Pub. No.: US 2022/0022485 A1
(43) Pub. Date: Jan. 27, 2022

(54) DEVICE FOR PREPARING A FROZEN FOOD PRODUCT FROM A LIQUID MIXTURE

(71) Applicant: Frederik Van Isacker, Zaventem (BE)

(72) Inventor: Frederik Van Isacker, Zaventem (BE)

(73) Assignee: KEMPISCHE BRIK CENTRALE, Zaventem (BE)

(21) Appl. No.: 17/021,833

(22) Filed: Sep. 15, 2020

Related U.S. Application Data
(63) Continuation of application No. PCT/EP2020/070864, filed on Jul. 23, 2020.

(51) Int. Cl. A23G 9/12; A23G 9/22

(52) U.S. Cl. CPC A23G 9/12; A23G 9/224

(57) ABSTRACT

A device is provided for preparing a frozen food product from a liquid mixture wherein the messy removal of the stirring unit is alleviated. The device includes a cup holder, a cooling unit, and a stirring unit having a stirring element, a motor, and a coupling element configured for releasably coupling the stirring element to the motor. The stirring element is releasably coupled to the coupling element by a bayonet coupling, and the motor is arranged for rotating in a first direction during an operational phase, thereby imparting a forward stirring motion to the stirring element, and for rotating in a second direction opposite to the first direction during a termination phase following the operational phase, thereby imparting a reverse stirring motion to the stirring element such that the stirring element decouples from the coupling element.

### TECHNICAL FIELD

The present disclosure relates to a device for preparing a frozen food product, such as for example ice cream or sorbet, from a liquid mixture, as well as to the use of such a device.

### BACKGROUND

Devices for preparing a frozen food product, such as for example ice cream or sorbet, from a liquid mixture, are known in the prior art. The patent publication WO2015169841 A1 discloses such a device. The device comprises the following elements:

a cup holder comprising a cavity configured for releasably receiving a cup in which the frozen food product is to be prepared from the liquid mixture,

a cooling unit configured for cooling the cavity of the cup holder; and

a stirring unit comprising
a stirring element configured for stirring with a stirring motion the liquid mixture in the cup for preparing the frozen food product, wherein the stirring element comprises an elongated rod extending along an elongation axis and at least one stirring blade connected to the elongated rod,
a drive system configured for driving the stirring motion of the stirring element in the cup, wherein the drive system comprises a motor and a coupling element configured for releasably coupling the stirring element to the motor and configured for transforming the rotation of the motor into the stirring motion of the stirring element, wherein the motor is arranged for rotating in a first direction during an operational phase, thereby imparting a forward stirring motion to the stirring element, and wherein the coupling element comprises coupling means to releasably couple with complementary coupling means provided on the stirring element,

wherein the at least one stirring blade is arranged to contact the cup during the operational phase, wherein the coupling means of the stirring element are provided on the elongated rod, wherein the coupling means of the stirring element and of the coupling element comprise magnets or clips.

A problem with the device from WO2015169841, as well as with other devices from the prior art, is that, when the frozen food product is obtained and the operational phase is thus terminated, the stirring unit has to be lifted out of the cup such as to give the user access to the stirring element as well as to the cup. Upon lifting the stirring element out of the cup, a quantity of frozen food product will inevitably stick to the stirring element. If the user removes the cup from the cup holder in order to consume the frozen food product, the frozen food product adhered to the stirring element will start to melt and drip in the cup holder, thereby making the subsequent cleaning of the device more time consuming. Furthermore, if the user decides to remove the stirring element from the stirring unit prior to removing the cup from the cup holder, the user will soil his/her hands upon manipulating the stirring element.

### SUMMARY

It is an aim of the present disclosure to provide a device for preparing a frozen food product, such as for example ice cream or sorbet, from a liquid mixture, wherein the problem from the prior art is solved, i.e. to provide a device that is easy to clean after the operational phase has ended.

This aim or others is achieved according to the disclosure with a device showing the technical characteristics of the first claim. The device according to the present disclosure is a device comprises a cup holder comprising a cavity configured for releasably receiving a cup in which the frozen food product is to be prepared from the liquid mixture, a cooling unit configured for cooling the cavity of the cup holder; and a stirring unit preferably positioned above the cup holder, in particular above the cavity of the cup holder. The stirring unit comprises a stirring element configured for stirring with a stirring motion the liquid mixture in the cup for preparing the frozen food product and preferably also configured for scraping ice crystals from the walls of the cup. The stirring element comprises an elongated rod extending along an elongation axis and at least one stirring blade connected to the elongated rod. The stirring unit further comprises a drive system configured for driving the stirring motion of the stirring element in the cup. The drive system comprises a motor, preferably an electromotor such as a stepper motor, a synchronous motor, an induction motor or a reluctance motor. The motor preferably comprises a stator, a rotor and an output shaft connected to the rotor. The stirring unit further comprises a coupling element configured for releasably coupling the stirring element to the motor and configured for transforming the rotation of the motor into the stirring motion of the stirring element. The motor is arranged for rotating in a first direction during an operational phase, thereby imparting a forward stirring motion to the stirring element, and for rotating in a second direction opposite to the first direction during a termination phase following the operational phase, thereby imparting a reverse stirring motion to the stirring element. The at least one stirring blade is arranged to contact the cup during the operational phase and the termination phase. The coupling element comprises coupling means to releasably couple with complementary coupling means provided on the stirring element. The coupling means of the stirring element are provided on the elongated rod, wherein the coupling means of the stirring element comprise one of protrusions or slots, and wherein the coupling means of the coupling element comprise the other one of the protrusions or slots, wherein the protrusions and slots together form a bayonet type coupling arranged to remain coupled upon rotation of the stirring element in a first direction during the operational phase, i.e. when the stirring element moves along the forward stirring motion, and arranged to decouple upon rotation of the stirring element in the opposite direction during the termination phase, i.e. when the stirring element moves along the reverse stirring motion.

It has been found that the device of the present disclosure is not subjected to the problems of the prior art after the operational phase because the device of the present disclosure comprises specific coupling means and a termination phase following the operational phase, which combination guarantees a clean removal of the stirring element from the stirring unit after the operational phase. In particular, the device of the present disclosure comprises bayonet-type coupling means arranged to automatically decouple when rotated in one direction but to remain coupled upon rotation in the opposite direction. This is combined with providing a termination phase comprising reversing the rotation direction of the motor, and thus of the stirring motion of the stirring element, whilst the stirring element, in particular the stirring blade of the stirring element, remains in contact with the cup, for example with the cup bottom wall and/or with the cup side wall. Due to the friction between the stirring element and the cup, the bayonet-type coupling means will decouple in the termination phase, but remain coupled in the operational phase. The termination phase furthermore preferably comprises, after having reversed the direction of the motor for a predetermined time, for example for at least one rotation of the stirring element, lifting the stirring unit, i.e. at least a part of the stirring unit comprising the coupling element, away from the cavity of the cup holder, i.e. into the open position as will be described below. Whilst the stirring unit is lifted, the stirring element, which is decoupled from the stirring unit, will remain in the cup. The user can then easily grasp the elongated rod of the stirring element in order to remove the stirring element from the cup. At least a part of the elongated rod is after all clean, because is resided inside of the coupling element during the operational phase.

In an embodiment of the present disclosure, the bayonet-type coupling means are arranged to decouple upon rotation of the stirring element in the reverse stirring motion during the termination phase, but only if the moment exerted on the coupling means exceeds a predetermined moment threshold. The bayonet-type coupling means have been designed such as to decouple under influence of predetermined moment threshold, for example by providing a predetermined clearance between the slot and protrusion of the bayonet-type coupling means such that a predetermined amount of friction between the slot and the protrusion has to be overcome for them to decouple, or for example by providing obstacles inside of the slot over which the protrusion has to be dragged. According to an embodiment, the predetermined moment threshold is chosen such that the mere friction between the stirring element and the cup walls, for example the cup bottom wall and or the cup side wall, decouples the bayonet-type coupling means. In some embodiments, the friction between the stirring element and the cup walls is the friction whilst the stirring element is pushed against the cup walls due to the stirring unit being in a closed position as will be explained below. It has been found that the frozen food product has a higher viscosity than the liquid mixture from which it is prepared. According to an embodiment, the predetermined moment threshold is chosen such that the sum of the friction between the stirring element and the cup walls, and the viscous drag of the stirring element moving through the frozen food product, decouples the bayonet-type coupling means. In the embodiment the bayonet type coupling is arranged to remain coupled upon rotation of the stirring element in a first direction during the operational phase and arranged to decouple upon rotation of the stirring element in the opposite direction during the termination phase if the frozen food product is obtained. This embodiment has the advantage that the bayonet-type coupling means do not decouple if the device prematurely enters the termination phase, i.e. because the operational phase has been terminated before the frozen food product is obtained for example because of a manual overwrite or because of a device failure, because the amount of viscous drag of the liquid mixture will be insufficient to decouple the bayonet-type coupling means. This enables the user or the device itself to notice that the frozen food product is not ready and to prolong the operational phase.

According to an embodiment of the present disclosure, the coupling means of the stirring element comprise protrusions, and the coupling means of the coupling element comprise slots. The present embodiment makes the cleaning of the device easier. It is after all the stirring element that is in direct contact with the liquid mixture and the final frozen food product, and it is thus the stirring element that requires the most frequent cleaning. It has been found that cleaning a surface provided with a protrusion is easier than cleaning a surface provided with a slot, because the slot is more difficult to access.

According to an embodiment of the present disclosure, the slots of the coupling means extend in a circumferential direction with respect to a rotational axis, allowing the protrusions of the complementary coupling means to be moved into the slots by rotating the protrusions along the rotational axis. In order to facilitate the coupling and decoupling of the coupling means, the rotational axis around which the slots extend is equal to first rotational axis as will be described below. The rotational axis around which the slots extend is in particular equal to the elongation axis of the stirring element. According to an embodiment of the present disclosure, the slots terminate in an abutment surface such as to limit the movement of the protrusions into the slots, i.e. upon moving the stirring element along the forward stirring motion.

According to an embodiment of the present disclosure, during the operational phase the cooling unit and the motor of the stirring unit are active such as to transform liquid mixture into the frozen food product. The cooling unit and the motor of the stirring unit for example receive instructions to start working from a CPU. During the operational phase the cooling unit for example cools the cavity of the cup holder according to a predetermined cooling program, and the motor of the stirring unit for example starts rotating in the first direction, thereby imparting the forward stirring motion to the stirring element via the coupling element of the stirring unit. During the operational phase, the motor of the stirring unit can for example be instructed to rotate in the first direction according to a driving program comprising different rotational speeds and/or torque levels as a function of time. The operational phase is terminated when the frozen food product has been obtained. The determination of obtaining of the frozen food product can be implemented in different manners, for example by monitoring a time limit or by monitoring the consistency of the liquid mixture for example by measuring the amount of torque exerted by the motor of the stirring unit. The operational phase can also be terminated before the frozen food product has been obtained, for example by a manual overwrite i.e. because the user presses a stop button on the device. The termination phase starts after the operational phase is terminated. During the termination phase, the direction of the motor is reversed such as to create the reverse stirring motion of the stirring element. Additionally, during the termination phase, the stirring unit preferably remains in the closed position as will be explained below. Additionally, during the termination phase, the speed of the motor is preferably reduced to a speed lower than the average speed of the motor during the operational phase. Additionally, during the termination phase, the cooling unit is preferably arranged to cool the cavity of the cup holder to a temperature higher than the average temperature during the operational phase, such as to merely prevent the frozen food product from melting. Alternatively, during the termination phase, the cooling unit is shut down.

According to an embodiment of the present disclosure, the coupling element comprises a fixed part preferably provided at a fixed position relative to the motor, in particular relative to the stator of the motor, and a moveable part moveably arranged relative to the fixed part. The moveable part comprises a rotor part arranged during the operational phase to rotate, under influence of the motor of the stirring unit, with respect to the fixed part in a first direction along a rotational axis, and arranged during the termination phase following the operational phase to rotate, under influence of the motor of the stirring unit, with respect to the fixed part in a second direction along the rotational axis, wherein the second direction is the opposite direction of the first direction. The moveable part further comprises a translating part attached to the rotor part such as to follow during the operational phase the rotation of the rotor part. The translating part further comprises the coupling means of the coupling element.

According to an embodiment of the present disclosure, the translating part is attached to the rotor part by a spring member such as to enable during an initialization phase prior to the operational phase the translation of the translating part with respect to the rotor part along a first translational axis. In some embodiments, the translation of the translating part with respect to the rotor part during the initialization phase results in the translation of the translating part with respect to the fixed part, for example because the rotor part is translationally fixed, i.e. not allowed to translate, with respect to the fixed part along the first translation axis. In some embodiments, the spring member comprises a spring such as a helical spring, an elastic material spring or a pneumatic spring. The spring like arrangement of the translating part of the present embodiment allows to absorb distance variations between the stirring element and the cup walls and to thrust the stirring element against the cup walls

According to an embodiment of the present disclosure the stirring unit is moveably arranged relative to the cup holder, for example by moving at least the fixed part but preferably the entirety of the stirring unit, between on the one hand a loose position in which the stirring element does not contact the cup holder or, in use, the cup received in the cup holder, and on the other hand a contact position in which the stirring element contacts the cup holder or, in use, the cup received in the cup holder. In some embodiments, the stirring unit is further moveable when it is in the loose position, for example by moving at least the fixed part but preferably the entirety of the stirring unit, from a first loose position where the stirring element first comes loose from the cup holder or in use the cup received in the cup holder, up to an opened position in which the cavity of the cup holder is accessible for example enabling the placement or removal of a cup into the cavity. In some embodiments, the stirring unit is moveable by manual action, but can also be motorised. According to an implementation of the embodiment, the moveable arrangement of the stirring unit relative to the cup holder is a translational arrangement along a second translation axis. The second translational axis is preferably parallel to the gravitational acceleration vector, in particular when the device is in use. Alternatively, the moveable arrangement of the stirring unit relative to the cup holder is a rotational arrangement for example around an axis perpendicular to the first translation axis for example parallel to the ground level, and wherein the stirring unit is pivoted between the above mentioned positions. According to a further embodiment, when the stirring unit is in the contact position, the stirring element pushes the translating part towards the rotor part, and thus towards the fixed part, along the first translation axis. According to the embodiment, when the stirring unit is in the contact position, for example starting from the position of first contact i.e. the first contact position, the fixed part, and preferably the entire stirring unit apart from the stirring element and the translating part coupled to the stirring element, is further moveable, for example along the second translation axis, towards the cup holder up to a closed position in which the distance along the first translation axis between the fixed part, for example a proximity sensor such as a Hall sensor provided on the fixed part, and the translating part, for example magnetised means provided on the translating part in order to interact with the proximity sensor, is below a predetermined proximity threshold. In some embodiments, the steps of moving (the fixed part of) the stirring unit from the open position to the closed position is referred to as the initialization phase. According to an embodiment, the first translational axis is parallel to the second translational axis, for example when the device is in use parallel to the gravitational acceleration vector. This embodiment ensures that the translation of the (fixed part of the) stirring unit towards the cup holder and the translation of the stirring element towards the rotor part are aligned, thereby optimally allowing the stirring element to move towards the rotor part upon the stirring unit moving from the first contact position to the closed position.

According to an embodiment, the fixed part comprises a proximity sensor arranged to detect the distance of the translating part relative to the fixed part, in particular relative to the proximity sensor, along the first translational axis and to generate an activation signal when the distance is below a predetermined proximity threshold. It has been found that the device according to the present embodiment guarantees a correct coupling of the stirring element to the coupling element. In particular, in the device of the embodiment, the operational phase is only started after an activation signal has been generated, indicating that the stirring element applies a sufficient pressure to the cup walls to guarantee a correct mixing of the liquid mixture and to guarantee a correct scraping of the ice crystals being formed on the cup walls during the operational phase.

According to an embodiment of the present disclosure, the translating part comprises magnetised means configured to generate a magnetic field. The magnetised means preferably are one or more permanent magnets. In some embodiments, the translating part is elongated and extends along the first translation means between opposite ends. In some embodiments, the magnetised means are provided at the end of the translating part that is most proximate to the fixed part, in particular that is most proximate to the proximity sensor provided on the fixed part, along the first translation axis. According to the embodiment, the proximity sensor is a Hall sensor configured to measure the magnetic flux created by the magnetic field, i.e. by the magnetic field generated by the magnetised means of the translating part. The Hall sensor is arranged to detect the distance of the translating part, in particular of the magnetised means, relative to the fixed part, in particular relative to the hall sensor, along the first translational axis and to generate an activation signal when the distance is below a predetermined proximity threshold. It has been found that the present embodiment alleviates the need to provide electronic components on the translating part, which is a moving component, thereby making the device less prone to damage and making the assembling of the device less complex. The electronic component in the present embodiment is the Hall sensor which is provided on the fixed part, which is a non-moving part. Furthermore, it has been found that providing the magnetised means on the translating part, for example as opposed to on the stirring element, increases the durability of the device. Upon cleaning the device, the stirring element is removed from the drive system, and is separately cleaned in a washing machine. In case the magnetised means would have been provided on the stirring element, the magnetisation of the magnetised means would have rapidly deteriorated over time due to the increased temperatures to which the stirring element is subjected in the washing machine. Furthermore, it has been found that providing the magnetised means on the translating part, for example as opposed to on the stirring element, decreases the cost of the device, because the magnetised means are expensive components and because the stirring element has to be replaced more often than the translating part. Due to the scraping action of the stirring element against the cup walls, the stirring element is after all more prone to wear than the translating part, and thus requires a more frequent replacement. Furthermore, the stirring element is releasably attached to the remainder of the device, thereby increasing the risk that the stirring element would get lost and thus would need replacement.

According to an embodiment of the present disclosure, the elongated rod of the stirring element extends along an axis referred to as the elongation axis, for example in a substantially rectilinear manner. The elongation axis is for example the symmetry axis of the elongated rod or of the stirring element in general. In an embodiment the elongated rod is a hollow tube for example a cylindrical hollow tube.

According to an embodiment of the present disclosure, the stirring element, i.e. the assembly of the stirring rod and the stirring blade, is devoid of magnetization means. This reduces the costs of the stirring element. In some embodiments, the elongated rod of the stirring element, and preferably also the stirring blade of the stirring element, has a relative permeability of below 2. This reduces the amount of flux leakage from the magnetised means of the translating part.

According to an embodiment of the present disclosure, in use, the elongation axis is parallel to the first translational axis. This alignment ensures that the force exerted by the cup walls onto the stirring element when the stirring unit is in the contact position, is optimally transferred to the translating part, thereby optimally moving the translating part towards the rotor part and as a consequence towards the fixed part upon moving the (fixed part of the) stirring unit towards the cup holder.

According to an embodiment of the present disclosure, the stirring motion comprises a first rotation around a first rotational axis. The first rotational axis is preferably parallel to the gravitational vector when the device is in use. The first rotational axis is preferably parallel to the first translation axis. The first rotational axis is preferably coinciding with the elongation axis of the elongated rod. In a first embodiment, the stirring motion is not a planetary motion. In said first embodiment, the rotor part is arranged to be rotated along the first rotational and the translating part is arranged to be rotated along said first rotational axis because of the coupling between the rotor part and the translating part. In a second embodiment, the stirring motion is a planetary motion as explained next. In some embodiments, the stirring motion furthermore comprises a superposed second rotation around a second rotational axis, wherein the second rotational axis is not coinciding with the first rotational axis. The second rotational axis is preferably parallel to the gravitational vector when the device is in use. The second rotational axis is preferably parallel to the first translation axis such as to create a planetary stirring motion. The second rotational axis is preferably parallel to, but not coinciding with, the elongation axis of the elongated rod such as to create a planetary stirring motion. In said second embodiment, the rotor part is arranged to be rotated along the second rotational axis and the translating part is arranged to be rotated along the first rotational axis. The first rotational axis thereby being rotated along with the rotor part around the second rotational axis. In some embodiments, the coupling element comprises a planetary motion gear for transforming the rotation of the motor of the stirring unit into the planetary stirring motion, wherein the rotor part is a sun gear rotationally arranged around the second rotational axis, the translating part is a planet gear rotationally arranged around the first rotational axis, and the fixed part is a stationary ring gear. In some embodiments, the sun gear comprises a disc preferably connected to a shaft in a flanging manner, wherein the shaft preferably extends along the second rotational axis and wherein the shaft is preferably connected to the output shaft of the motor of the stirring unit. In some embodiments, the second rotational axis is provided substantially at the centre of the ring gear. In some embodiments, the disc of the sun gear is a toothless disc i.e. devoid of teeth configured to mesh with corresponding teeth on the planet or ring gear. In some embodiments, the planet gear extends through a borehole in the disc of the sun gear, thereby coupling during the operational phase the rotation along the second rotational axis of on the one hand the disc of the sun gear and on the other hand the planet gear i.e. such that both have the same number of rpm along the second rotational axis. The planet gear is preferably rotated along the second rotational axis either a) by meshing the teeth of the planet gear with teeth provided on the shaft of the sun gear, in which case the disc is coupled to the shaft of the sun gear in such a manner that rotation along the second rotational axis is allowed between them, or b) by following the rotation of the disc along the second rotational axis, in which case the shaft of the sun gear is coupled to the disc of the sun gear in such a manner that the disc is directly rotated by the shaft i.e. by not allowing rotation along the second rotational axis between them. In the latter implementation, the shaft of the sun gear is preferably devoid of teeth, because the advancement of the planet gear along the second rotational axis does not require meshing of the between the teeth of the shaft of the sun gear and the teeth of the planet gear. The planet gear is preferably supported by the disc via the spring member such as to enable during an initialization phase the translation of the planet gear with respect to the sun gear along the first translational axis. The planet gear preferably comprises a gear part and a remaining part. The gear part of the planet gear comprises teeth for meshing with the teeth of the ring gear and optionally the shaft of the sun gear. The remaining part of the planet gear comprises an abutment surface whereon the spring means abut, and comprises the coupling means. The spring member furthermore supports the planet gear such as to allow during the operational phase the rotation of the planet gear along the first rotational axis for example by providing a bearing between the translating part and the rotor part or for example by implementing the spring member as a spring provided with a bearing at one of its ends. The ring gear meshes with the planet gear such as to rotate the planet gear along the first rotational axis during the operational phase and the termination phase. The teeth of the ring gear are preferably extended along the first translational axis such as to allow translation of the planet gear with respect to the sun gear whilst maintaining a meshed contact between the ring gear and the planet gear.

It is a further aim of the present disclosure to provide a method for preparing a frozen food product from a liquid mixture, the method comprises providing the device as described above, moving during an operational phase the stirring element in the forward stirring motion, and moving during a termination phase following the operational phase the stirring element in the reverse stirring motion whilst maintain contact between the stirring element and the cup walls such that the stirring element decouples from the coupling element.

### DESCRIPTION OF THE DRAWINGS

The disclosed subject matter will be further elucidated by the following description and the appended figures.

FIG. 1 shows a perspective overview of an embodiment of the device according to the present disclosure.

FIG. 2 is a cross-section of the device of FIG. 1 along the section AA, and shows a detailed view of the stirring unit and the cup received in the cup holder when the stirring element is decoupled and removed from the stirring unit.

FIG. 3 is a cross-section of the device of FIG. 1 along the section AA, and shows a detailed view of the stirring unit and the cup received in the cup holder when the stirring element is coupled to the stirring unit, and wherein the stirring unit is in the closed position.

FIG. 4 shows a selection of the components of FIG. 1, in particular a front view of the stirring element coupled to the translating part of the stirring unit.

FIG. 5 shows a top cross-sectional view along line BB in FIG. 4, wherein the complementary coupling means are decoupled.

FIG. 6 shows a top cross-sectional view along line BB in FIG. 4, wherein the complementary coupling means are coupled.

### DETAILED DESCRIPTION

The present disclosure will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present disclosure, the only relevant components of the device are A and B.

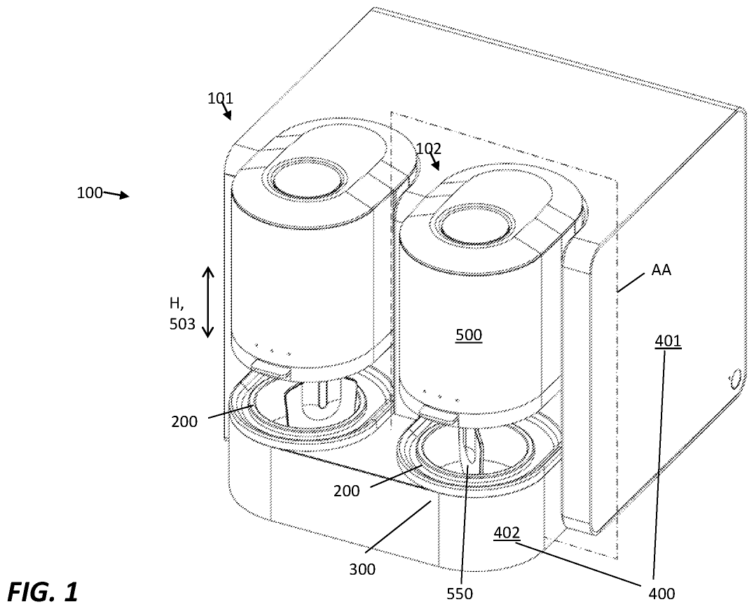

FIG. 1 shows a device 100 according to an embodiment of the present disclosure for preparing a frozen food product, such as for example ice cream or sorbet, from a liquid mixture. The device 100 comprises a first sub-unit 101 which is arranged for preparing a frozen food product in a first cup 200, and a second sub-unit 102 which is arranged for preparing a frozen food product in a second cup 200, different from the first cup 200. The first sub-unit 101 and the second sub-unit 102 are arranged in a similar manner and operate independent from each other, such that two cups 200 of frozen food product can be prepared separate from each other. In alternative embodiments, the device 100 may comprise only a single sub-unit 101, 102, or may be provided with more than two of the sub-units 101, 102. Since the first sub-unit 101 and the second sub-unit 102 are arranged in similar manner, the features of the device 100 will be discussed below only with respect to one of the sub-units 101, 102. The cup 200 comprises a cup wall which encloses a holding volume. The holding volume is arranged for holding the liquid mixture therein, and also for holding the frozen food product therein after the frozen food product has been prepared form the liquid mixture. At the top, the cup 200 comprises a top opening via which the holding volume can be accessed. The cup 200 may be pre-filled with the liquid mixture, whereby the top opening is sealed off by one or more sealing elements (not shown), such as a sealing membrane and a lid. The sealing elements can then be taken off the cup 200 before the cup 200 is to be used with the device 100. The cup 200 may also be a reusable cup 200, which is filled right with a liquid mixture from a package pre-filled with liquid mixture or with a self-made liquid mixture before the cup 200 is to be used with the device 100.

The device 100 comprises at its bottom a cup holder 300 which is arranged for holding the cup 200, preferably in a fixed position, while the frozen food product is being prepared in the cup 200. Therefore, the device 100 comprises a cavity in which the cup 200 can be received via an entrance opening.

The entrance opening of the cavity is located in a first upper surface of the cup holder 300.

The device 100 also comprises a cooling unit 400. The cooling unit 400 is arranged for cooling the cavity of the cup holder 300, and more specifically for cooling a cup 200 received in the cavity. The cooling unit 400 should be arranged to provide sufficient cooling for freezing liquid mixture contained in the cup 200 while preparing a frozen food product from the liquid mixture. The cooling unit 400 may comprise auxiliary components 401 such as one or more compressors, motors for driving the compressors, and condensers. The cooling unit 400 further comprises cooling pipes, which are arranged around each cavity such as to form one or more evaporators 402, and through which a cooling fluid is transported for cooling the cavities. The cooling unit 400 may however also be arranged in any other way know to the person skilled in the art for cooling the cavity of a device 100 for preparing a frozen food product from a liquid mixture.

The device 100 also comprises a stirring unit 500 which is arranged above the cup holder 300. The stirring unit 500 comprises a stirring element 550, and is configured for stirring the liquid mixture in the cup 200 by said stirring element 550 for preparing the frozen food product. The stirring element 550 is removably connectable to the stirring unit 500, such that the stirring element 550 can be taken out of the device 100 for cleaning.

The stirring unit 500 comprises a moveable portion which is moveable along a height direction H, further also referred to as the second translation direction 503 between a first position and a second position. In the first position, also referred to as the open position, the stirring element 550 is arranged outside of the cup 200, such that it is easily accessible for disconnecting it from the stirring unit 500 for cleaning and for connecting it to the stirring unit 500. In the second position, also referred to as the contact position, the stirring element 550 is arranged inside the cup 200 such that the stirring unit 500 can stir the liquid mixture in the cup 200 by the stirring element 550 for preparing the frozen food product.

The stirring unit 500 is also provided with a protection screen (not shown) which extends downwards from the he stirring unit 500, and moves together with the stirring unit 500. When the of the stirring unit 500 is in the second position, the protection screen closes off an area located above the cup 200 and between the cup holder 300 and the stirring unit 500. This prevents access to the moving stirring element 550 when the frozen food product is being prepared, which is beneficial for safety. A further safety feature is that, in the second position of the stirring unit 500, the bottom edge of the protection screen supports on the upper surface of the cup holder 300, such that it is difficult to get underneath the protection screen and lift it up to gain access to the closed off area. The protection screen is also beneficial for the cleanliness of the device 100, since it contains spilled liquid mixture or frozen food product in the closed off area, and prevents it from further spreading over the device 100.

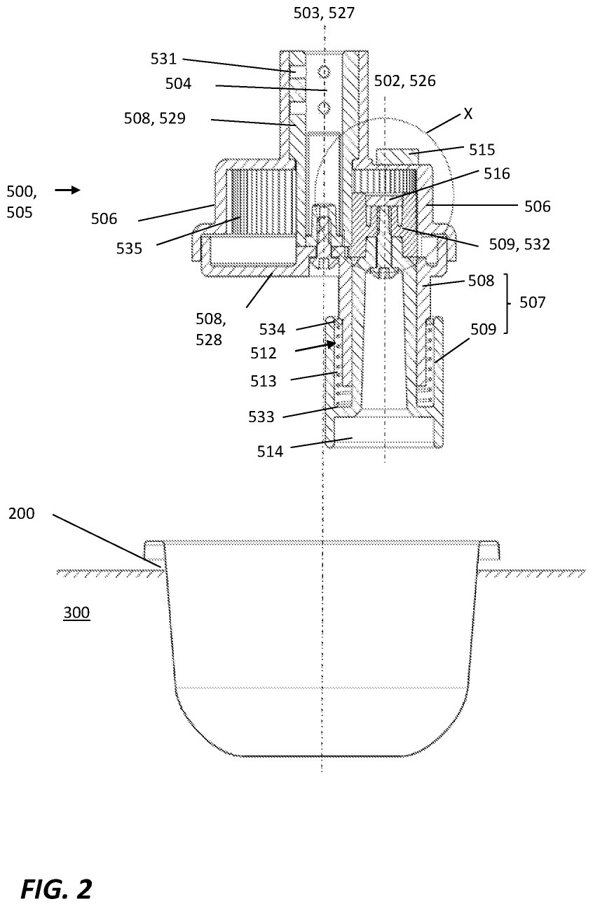

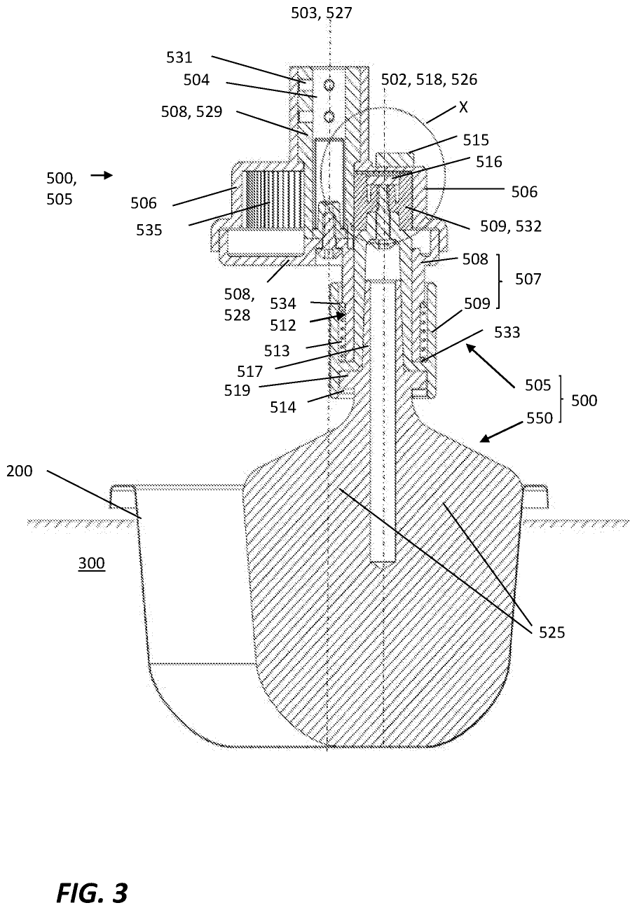

FIGS. 2 and 3 are cross-sections of the device of FIG. 1 along the section AA, and shows a detailed view of the stirring unit 500 and the cup 200 received in the cup holder 300. In FIG. 2 the stirring element 550 is removed from the stirring unit 500 and the stirring unit 500 is in the open position. In FIG. 3 the stirring element 550 is coupled to the stirring unit 500, and the stirring unit 500 is in the closed position. FIGS. 2-3 show an embodiment of the device according to the present disclosure wherein for clarity reasons not every component is shown or is shown schematically. In the FIGS. 2-3 the device 100 is shown comprising a cup 200 received in the cavity of a cup holder 300 and a stirring unit 500 positioned above the cup holder 300. The stirring unit 500 comprises a stirring element 550 configured for stirring with a stirring motion the liquid mixture in the cup 200 for preparing the frozen food product and also configured for scraping ice crystals from the walls of the cup 200. The stirring unit 500 further comprises a drive system configured for driving the stirring motion of the stirring element 550 in the cup 200. The drive system comprises a motor (not shown), comprising a stator (not shown), a rotor (not shown) and an output shaft 504 connected to the rotor. The drive system further comprises a coupling element 505. The coupling element 505 is configured for releasably coupling the stirring element 550 to the motor. FIGS. 2 and 3 for example shows the device 100 wherein the stirring element 550 is not coupled to the coupling element 505, and FIG. 3 shows the device 100 wherein the stirring element 550 is coupled to the coupling element 505. The coupling element 505 is configured for transforming the rotational movement of the output shaft 504 of the motor into the stirring motion of the stirring element 550. The coupling element 505 comprises a fixed part 506 provided at a fixed position relative to the stator of the motor, and a moveable part 507 moveably arranged relative to the fixed part 506. The drive shaft 504 of the motor of the stirring unit 500 extends through a bore in the fixed part 506. The moveable part 507 comprises a rotor part 508 arranged during an operational phase to rotate with respect to the fixed part 506 and a translating part 509 attached to the rotor part 508 by a spring member 512 such as to enable during an initialization phase the translation of the translating part 509 with respect to the rotor part 508 along a first translational axis 502 and such as to follow during the operational phase the rotation of the rotor part 508. The translation of the translating part 509 with respect to the rotor part 508 during the initialization phase results in the translation of the translating part 509 with respect to the fixed part 506, because the rotor part 508 is translationally fixed, i.e. not allowed to translate, with respect to the fixed part 506 along the first translation axis 502. The spring member 512 comprises a helical spring 513. The translating part 509 furthermore comprises coupling means 514 to releasably couple with the stirring element 550. The fixed part 506 comprises a proximity sensor 515 arranged to detect the distance of the translating part 509 relative to the fixed part 506 along the first translational axis 502 and to generate an activation signal when the distance is below a predetermined proximity threshold. The translating part 509 comprises magnetised means 516, i.e. magnets configured to generate a magnetic field. The magnetised means 516 are provided at the upper end of the translating part 509 because this upper end is most proximate to the fixed part 506, in particular most proximate to the proximity sensor 515 provided on the fixed part 506. The proximity sensor 515 is a Hall sensor configured to measure the magnetic flux created by the magnetic field, i.e. by the magnetic field generated by the magnetised means 516 of the translating part 509.

The stirring unit 500 is moveably arranged relative to the cup holder 300 between on the one hand a loose position in which the stirring element 550 does not contact the cup 200, in particular its bottom wall, received in the cup holder 300, and on the other hand a contact position in which the stirring element 550 contacts the cup 200, in particular its bottom wall, received in the cup holder 3X). The moveable arrangement of the stirring unit 500 relative to the cup holder 300 is a translational arrangement along a second translation axis 503 parallel to the gravitational acceleration vector. The second translational axis 503 is parallel to the first translational axis 502. The stirring unit 500 is further moveable along the second translational axis 503, when it is in the loose position, from a first loose position where the stirring element 500 first comes loose from the cup 200, in particular its bottom wall, received in the cup holder 300, up to an opened position in which the cavity of the cup holder 300 is accessible for example enabling the placement or removal of a cup 200 into the cavity. FIG. 2 shows the stirring unit 500 in said loose position. As shown in FIG. 3, when the stirring 500 unit is in the contact position, the stirring element 550 pushes the translating part 509 towards the rotor part 508, and thus towards the fixed part 506, along the first translation axis 502. When the stirring unit 500 is in the contact position, the fixed part 506, and more in particular the entire stirring unit 500 apart from the stirring element 550 and the translating part 509 coupled to the stirring element 550, is further moveable along the second translation axis 503, towards the cup holder 300 starting from the position of first contact i.e. the first contact position, up to a closed position in which the distance between the fixed part 506, in particular the Hall sensor 5015, and the translating part 509, in particular the magnetised means 5016, is below the predetermined proximity threshold. FIG. 3 shows the (fixed part 506 of) the stirring unit 550 in the closed position. The steps of moving (the fixed part 506 of) the stirring unit 550 from the open position to the closed position is referred to as the initialization phase.

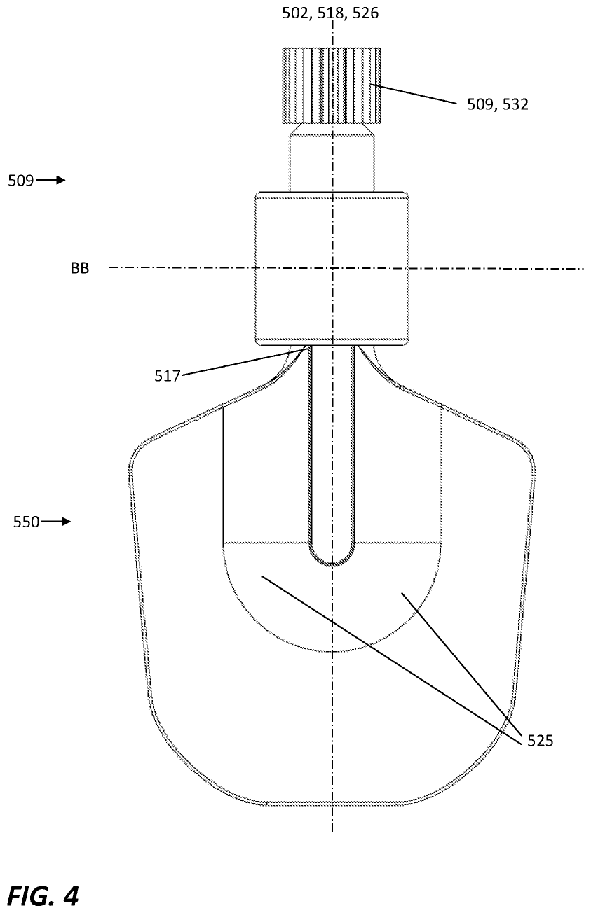

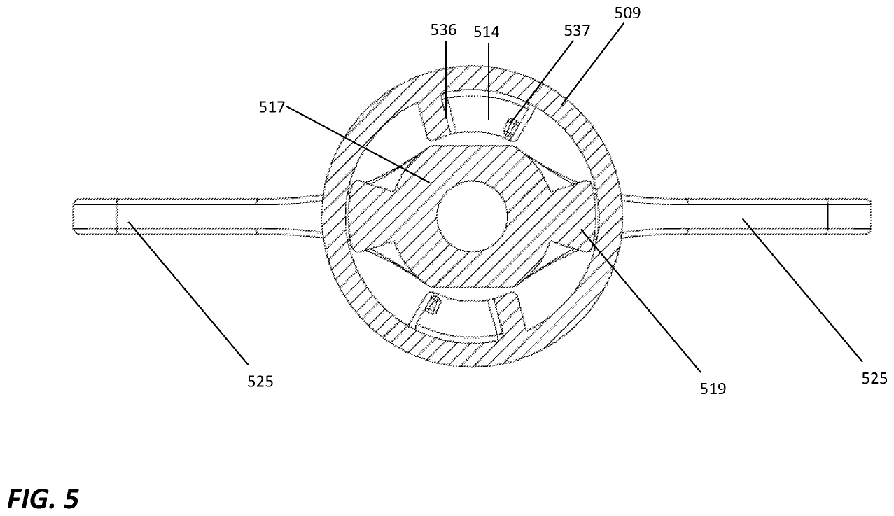

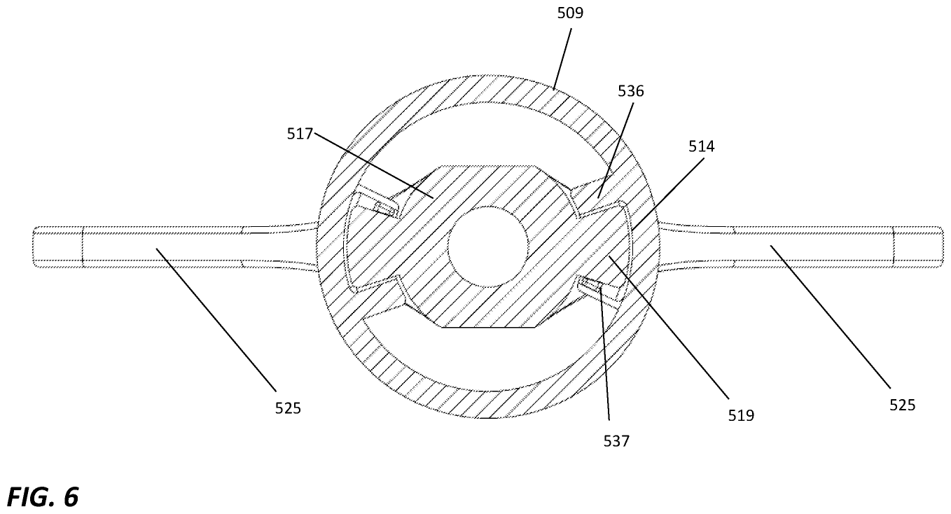

As shown in the FIGS. 2-4, the stirring element 550 comprises an elongated rod 517. The elongated rod 517 is a hollow cylindrical tube extending along an axis referred to as the elongation axis 518. The elongation axis 518 is the symmetry axis of the elongated rod 517 and of the stirring element 550 in general. Two stirring blades 525 configured for, in use, stirring the liquid mixture and for contacting the cup 200, are integrally connected to the elongated rod 517. As best shown in FIGS. 5-6, the elongated rod 517 comprises coupling means 519 complementary to the coupling means 514 of the coupling element 505. The coupling means 519 of the stirring element 550 and the coupling element 505 are respectively protrusions and slots. The protrusions and slots together form a bayonet type lock configured to remain coupled upon rotation of the stirring element 550 along a first rotational direction and configured to decouple upon rotation of the stirring element 550 along the opposite rotational direction. FIG. 5 shows the complementary coupling means 514, 519 in an uncoupled condition. Upon rotating the stirring element 550 in the forward stirring motion, in particular along a first direction around the first rotational axis 526, the complementary coupling means 514, 519 transition into the coupled condition as shown in FIG. 6. Upon rotating the stirring element 550 in the reverse stirring motion, in particular along the reverse direction around the first rotational axis 526, the complementary coupling means 514, 519 transition to from the coupled condition as shown in FIG. 6 into the uncoupled condition as shown in FIG. 5. The slots of the coupling means 514 extend in a circumferential direction with respect to the first rotational axis 526, allowing the protrusions of the complementary coupling means 519 to be moved into the slots by rotating the protrusions along the first rotational axis 526. The slots terminate in an abutment surface of an abutment element 536 such as to limit the movement of the protrusions into the slots. i.e. upon moving the stirring element 550 along the forward stirring motion. An obstacle 537, here implemented as a hole in the sidewall of the slot, is provided inside of the slot. In order to insert/remove the protrusion in/out of the slots, the protrusions has to be dragged over the obstacle 537. This requires the application of a predetermined amount of moment onto the coupling means 519 of the stirring element 550 with respect to the coupling means 514 of the coupling element 505. The obstacle 537 has been designed such that this predetermined amount of moment equals a desired predetermined moment threshold, i.e. the amount of moment at which one desires the bayonet-type lock 514, 519 to uncouple upon moving the stirring element 550 in the reverse stirring motion, for example because of the friction between the stirring blades 525 and the cup walls and optionally the viscous drag of the stirring blades 525 in the frozen food product. Providing the obstacle 537 has the further advantage that a sound is generated when the protrusion moves over the obstacle 537, thereby informing the user that the stirring element 550 is correctly coupled to the stirring unit 500.

The stirring motion comprises a first rotation around a first rotational axis 526. The first rotational axis 526 is parallel to the gravitational vector. The first rotational axis 526 is also parallel to the first translation axis 502. The first rotational axis 526 is more particularly coinciding with the elongation axis 518 of the elongated rod 517. The stirring motion furthermore comprises a superposed second rotation around a second rotational axis 527, wherein the second rotational axis 527 is not coinciding with the first rotational axis 526. The second rotational axis 527 is parallel to the gravitational vector. The second rotational axis 527 is also parallel to the first translation axis 502 such as to create a planetary stirring motion. The second rotational axis 527 is more particularly parallel to, but not coinciding with, the elongation axis 518 of the elongated rod 517 such as to create a planetary stirring motion. The reverse stirring motion comprises the same rotations around the same rotational axis as the forward stirring motion, and only differs in the direction of rotation, i.e. by rotating along the first and second rotational axis in the opposite directions. The coupling element 505 comprises a planetary motion gear 524 for transforming the rotation of the motor of the stirring unit 500 into the planetary stirring motion, wherein the rotor part 508 is a sun gear, the translating part 509 is a planet gear, and the fixed part 506 is a stationary ring gear. The sun gear 508 comprises a disc 528 connected to a shaft 529 in a flanging manner, wherein the shaft 529 extends along the second rotational axis 527 and wherein the shaft 529 is connected to the output shaft 504 of the motor of the stirring unit 500 via connection studs 531. The second rotational axis 527, and thus the shaft 529, is provided substantially at the centre of circle described by the teeth of the ring gear 506. The disc 528 of the sun gear 508 is a toothless disc i.e. devoid of teeth configured to mesh with corresponding teeth on the planet 509 or ring gear 506. The planet gear 509 extends through a borehole in the disc 528 of the sun gear 508, thereby coupling during the operational phase the rotation along the second rotational axis 527 of on the one hand the disc 528 of the sun gear 508 and on the other hand the planet gear 509 i.e. such that both have the same number of rpm along the second rotational axis 527. The planet gear 509 is rotated along the second rotational axis 527 by following the rotation of the disc 528 along the second rotational axis 527, i.e. the disc 528 drags the planet gear 509 along the second rotational axis 527. To that end the shaft 529 of the sun gear 508 is coupled to the disc 528 of the sun gear 508 in such a manner that the disc 528 is directly rotated by the shaft 529. The coupling between the disc 528 and the shaft 529 of the sun gear 508 in particular does not allow rotation along the second rotational axis 527 between them. The shaft 529 of the sun gear 508 is a toothless shaft, as it is not required to mesh with the teeth of the planet gear 509 in order to advance the planet gear 509 along the second rotational axis 527. The planet gear 509 is supported by the disc 528 via the spring member 512 such as to enable during an initialization phase the translation of the planet gear 509 with respect to the sun gear 508 along the first translational axis 502. The planet gear 509 comprises a gear part 532 and a remaining part. The gear part 532 of the planet gear 509 comprises teeth for meshing with the teeth of the ring gear 506. The upper part of the gear part 532 comprises the magnetised means 516. The remaining part of the planet gear comprises an abutment surface 533 whereon the spring member 512, in particular its helical spring 513, abuts, and comprises the coupling means 514. The spring member 512 furthermore supports the planet gear 509 such as to allow during the operational phase the rotation of the planet gear 509 along the first rotational axis 526 for example by implementing the spring member 512 as a spring 513 provided with a bearing 534 at its upper end. The teeth 535 of the ring gear 506 meshes with the planet gear 509 such as to rotate the planet gear 509 along the first rotational axis 526 during the operational phase. The teeth 535 of the ring gear 506 are extended along the first translational axis 502 such as to allow translation of the planet gear 509 with respect to the sun gear 508 whilst maintaining a meshed contact between the teeth 535 of the ring gear 506 and the teeth of the planet gear 509.

1. A device for preparing a frozen food product from a liquid mixture, the device comprising:
a cup holder comprising a cavity configured for releasably receiving a cup in which the frozen food product is to be prepared from the liquid mixture;
a cooling unit configured for cooling the cavity of the cup holder; and
a stirring unit, comprising:
a stirring element configured for stirring with a stirring motion the liquid mixture in the cup for preparing the frozen food product, wherein the stirring element comprises an elongated rod extending along an elongation axis and at least one stirring blade connected to the elongated rod; and
a drive system configured for driving the stirring motion of the stirring element in the cup, wherein the drive system comprises a motor and a coupling element configured for releasably coupling the stirring element to the motor and configured for transforming rotation of the motor into the stirring motion of the stirring element, wherein the motor is arranged for rotating in a first direction during an operational phase, thereby imparting a forward stirring motion to the stirring element, and for rotating in a second direction opposite to the first direction during a termination phase following the operational phase, thereby imparting a reverse stirring motion to the stirring element, and wherein the coupling element comprises coupling means to releasably couple with complementary coupling means provided on the stirring element,
wherein the at least one stirring blade is arranged to contact the cup during the operational phase and the termination phase, wherein the coupling means of the stirring element are provided on the elongated rod, wherein the coupling means of the stirring element comprise one of protrusions and slots, and wherein the coupling means of the coupling element comprise the other one of the protrusions and slots, wherein the protrusions and slots together form a bayonet type coupling arranged to remain coupled upon rotation of the stirring element in the first direction during the operational phase and arranged to decouple upon rotation of the stirring element in an opposite direction during the termination phase.

2. The device according to claim 1, wherein the coupling means of the stirring element comprise protrusions, and wherein the coupling means of the coupling element comprise slots.

3. The device according to claim 1, wherein the slots of the coupling means extend in a circumferential direction with respect to a rotational axis, allowing the protrusions of the complementary coupling means to be moved into the slots by rotating the protrusions along the rotational axis.

4. The device according to claim 3, wherein the slots terminate in an abutment surface such as to limit movement of the protrusions into the slots.

5. The device according to claim 1, wherein the bayonet type coupling is arranged to remain coupled upon rotation of the stirring element in a first direction during the operational phase and arranged to decouple upon rotation of the stirring element in the opposite direction during the termination phase, only if the frozen food product is obtained.

6. The device according to claim 3, wherein the coupling element comprises a fixed part, and a moveable part moveably arranged relative to the fixed part, wherein the moveable part comprises a rotor part arranged during the operational phase to rotate, under influence of the motor of the stirring unit, with respect to the fixed part in a first direction along the rotational axis, and arranged during the termination phase following the operational phase to rotate, under influence of the motor of the stirring unit, with respect to the fixed part in a second direction along the rotational axis, wherein the second direction is the opposite direction of the first direction, and wherein the moveable part further comprises a translating part attached to the rotor part such as to follow during the operational phase the rotation of the rotor part, and wherein the translating part comprises the coupling means of the coupling element.

7. The device according to claim 6, wherein the translating part is attached to the rotor part by a spring member such as to enable during an initialization phase prior to the operational phase the translation of the translating part with respect to the rotor part along a first translational axis.

8. The device according to claim 7, wherein the stirring unit is moveably arranged relative to the cup holder between:
a loose position in which the stirring element does not contact the cup holder and, in use, the cup received in the cup holder, and
a contact position in which the stirring element contacts the cup holder and, in use, the cup received in the cup holder.

9. The device according to claim 8, wherein the stirring unit is moveably arranged relative to the cup holder in a translational arrangement along a second translation axis.

10. The device according to claim 8, wherein when the stirring unit is in the contact position, the stirring element pushes the translating part towards the rotor part along the first translation axis.

11. The device according to claim 10, wherein when the stirring unit is in the contact position, the fixed part of the coupling element is further moveable towards the cup holder up to a closed position in which a distance along the first translation axis between the fixed part and the translating part is below a predetermined proximity threshold.

12. The device according to claim 9, wherein the first translational axis is parallel to the second translational axis, and wherein the elongation axis, in use, is parallel to the first translational axis.

13. The device according to claim 7, wherein the stirring motion comprises a first rotation around a first rotational axis coinciding with the elongation axis of the elongated rod.

14. The device according to claim 13, wherein the slots extend in a circumferential direction around the first rotational axis.

15. The device according to claim 13, wherein the rotor part is arranged to be rotated along the first rotational axis.

16. The device according to claim 13, wherein the stirring motion furthermore comprises a superposed second rotation around a second rotational axis, the second rotational axis being parallel to, but not coinciding with, the elongation axis of the elongated rod such as to create a planetary stirring motion.

17. The device according to claim 16, wherein the rotor part is arranged to be rotated along the second rotational axis and wherein the translating part is arranged to be rotated along the first rotational axis.

18. The device according to claim 17, wherein the coupling element comprises a planetary motion gear for transforming the rotation of the motor of the stirring unit into the planetary stirring motion, wherein the rotor part is a sun gear rotationally arranged around the second rotational axis, the translating part is a planet gear rotationally arranged around the first rotational axis, and the fixed part is a stationary ring gear.

19. The device according to claim 18, wherein:
the sun gear comprises a shaft extending along the second rotational axis and coupled to the motor of the stirring unit such as to rotate along the second rotational axis, and wherein the sun gear comprises a disc flanging with respect to the shaft,
the planet gear extends through a borehole in the disc of the sun gear such as to couple during the operational phase and the termination phase the rotation along the second rotational axis of, on the one hand, the disc of the sun gear and, on the other hand, the planet gear, and wherein the planet gear is supported by the disc via the spring member such as to enable during the initialization phase the translation of the planet gear with respect to the sun gear along the first translational axis, and such as to allow during the operational phase and the termination phase the rotation of the planet gear along the first rotational axis, and
the ring gear meshes with the planet gear such as to rotate the planet gear along the first rotational axis during the operational phase and the termination phase, and wherein teeth of the ring gear are extended along the first translational axis such as to allow translation of the planet gear with respect to the sun gear whilst maintaining a meshed contact between the ring gear and the planet gear.

20. A method for preparing a frozen food product from a liquid mixture, comprising:
providing the device according to claim 1;
moving during the operational phase the stirring element in the forward stirring motion; and
moving during the termination phase following the operational phase the stirring element in the reverse stirring motion while maintaining contact between the stirring element and walls of the cup such that the stirring element decouples from the coupling element.
